(19) United States
(12) Patent Application Publication
(10) Pub. No.: US 2015/0280312 A1
(43) Pub. Date: Oct. 1, 2015

(54) PORTABLE ELECTRONIC DEVICE WITH MERGED REAR HOUSING AND ANTENNA

(71) Applicant: Frank Thomas Poggio, Rolling Meadows, IL (US)

(72) Inventor: Frank Thomas Poggio, Rolling Meadows, IL (US)

(73) Assignee: BlackBerry Limited, Waterloo, ON (CA)

(21) Appl. No.: 14/420,849

(22) PCT Filed: Aug. 10, 2012
(86) PCT No.: PCT/US12/50412

§ 371 Date: May 28, 2015

(51) Int. Cl. H01Q 1/24

(52) U.S. Cl. CPC H01Q 1/243

(57) ABSTRACT

A portable electronic device includes a rear housing formed entirely of a modified plastic material configured for laser direct structuring, and an antenna formed on a surface of the rear housing using laser direct structuring.

### TECHNICAL FIELD

This disclosure relates generally to housings for use with portable electronic devices and, more particularly, to a housing that includes an antenna.

### BACKGROUND INFORMATION

Personal electronic devices have gained widespread use in recent years. These devices provide a variety of functions including, for example, telephoning, electronic messaging, and other personal information manager application functions. Some of these electronic devices are portable and include wireless capabilities. Portable electronic devices include, among others, mobile telephones, wireless personal digital assistants, and laptop computers with wireless capabilities.

Antennas are critical for wireless communication of Portable electronic devices. Antennas include one or more electrical conductors adapted to transmit electromagnetic energy into space and/or to collect electromagnetic energy from space. In some applications, antenna modules that include electrical conductors are attached to the electronic device. A commonly used antenna module includes a carrier (made, for example, of a plastic material) with an antenna structure attached to a housing of the electronic device. Attaching antenna carriers to the electronic device often increases manufacturing cost and complexity by increasing the number of parts required, and the number of operations required to produce the device. It would be beneficial to provide a simplified antenna structure for portable electronic devices to simplify assembly and to reduce cost.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIGS. 1A and 1B are front and rear views of an exemplary portable electronic device;

FIG. 2 is a perspective view of an exemplary rear housing of FIG. 1;

FIG. 3 is a cross-sectional view of the rear housing of FIG. 2 taken through plane 3-3 shown in FIG. 2; and

FIG. 4 is a perspective view of another exemplary rear housing of FIG. 1

FIG. 5 is a flowchart depicting the steps of an exemplary method for manufacturing consistent with the present disclosure.

### DETAILED DESCRIPTION

Reference will now be made in detail to exemplary embodiments, examples of which are illustrated throughout the drawings. Wherever possible, the same reference numbers are used in the drawings and the description to refer to the same or like parts.

The disclosure generally relates to a portable electronic device. Examples of portable electronic devices include mobile (e.g., handheld) wireless communication devices such as pagers, mobile phones, wireless organizers, personal digital assistants, wireless-enabled notebook computers, and any other known communication device having an antenna. In the discussion that follows, a mobile phone is used as an exemplary embodiment of the portable electronic device. However, it should be noted that the inventive aspects of the present disclosure are applicable to any electronic device with an antenna. Furthermore, while the following discussion and figures may at times be limited to devices having a single antenna, it should be understood that the devices and methods disclosed herein may accommodate a plurality of antennas manufactured in a similar fashion.

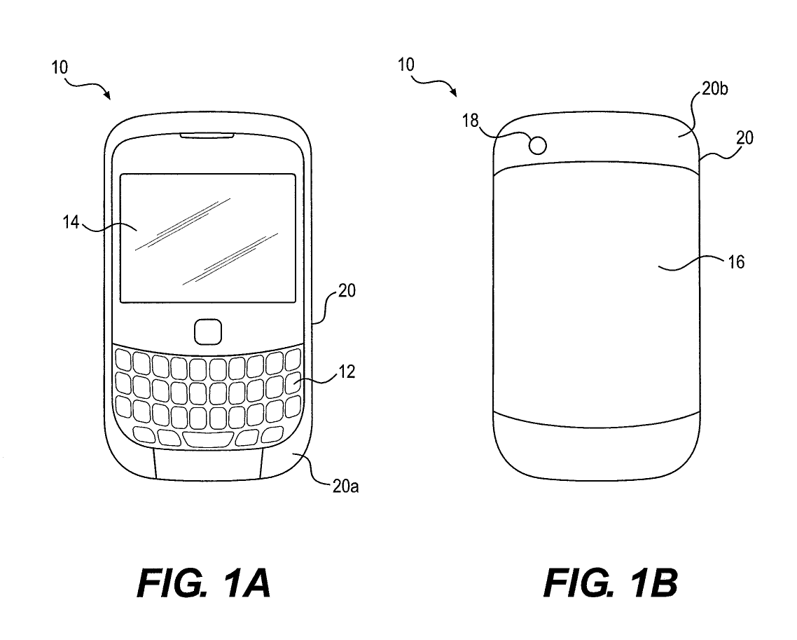

FIGS. 1A and 1B illustrate front and back views, respectively, of an exemplary embodiment of a mobile phone 10. In the description below, reference will be made to both FIGS. 1A and 1B. Mobile phone 10 includes a keypad 12, a display device 14, a battery door 16, and a camera 18 positioned in a housing 20. In addition to these identified components, mobile phone 10 may include components (such as, for example, speakers, lights, connectors, etc.) not specifically identified in FIGS. 1A and 1B. These components may be of any type (size, configuration, etc.) and serve any function. Since the different types and functions of these components are well known in the art, for the sake of brevity, they are not extensively discussed herein. Housing 20 of mobile phone 10, along with other components (such as, for example, keypad 12, display 14, and battery cover 16), may enclose an internal volume (i.e., space) within the mobile phone 10. This enclosed volume may include electronic circuitry that drives the operation of the mobile phone 10. These electronic circuits may include a variety of integrated circuit (IC) devices and circuit boards that electrically interconnect these IC devices.

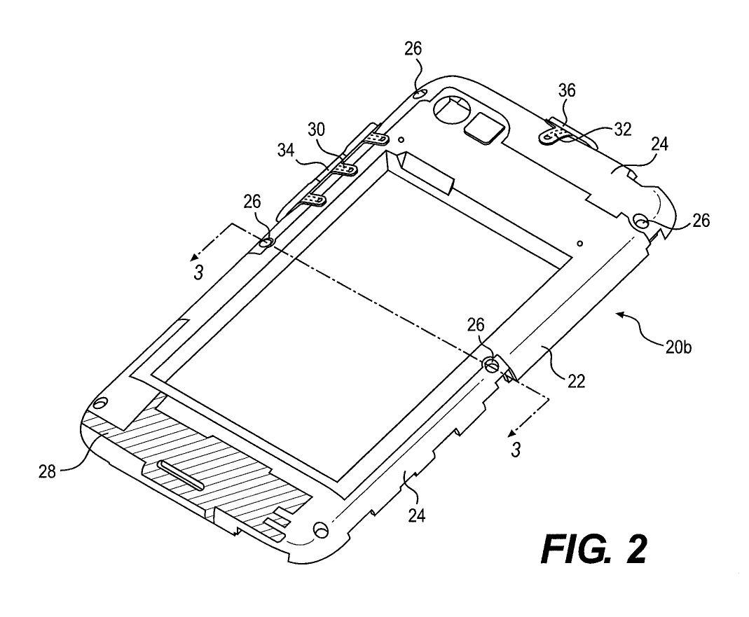

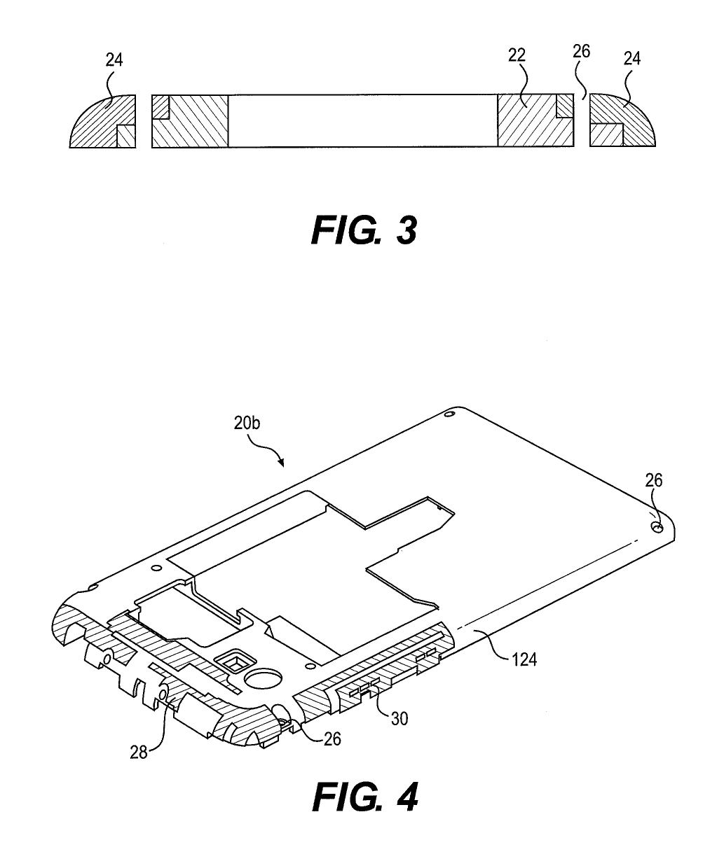

Housing 20 may include a front housing 20a and a rear housing 20b that join together to define a three-dimensional (3-D) shell. This 3-D shell may include openings into which components such as keypad 12, display device 14, battery door 16, and camera 18 fit to enclose the space containing the electronic circuits of the mobile phone 10. FIG. 2 illustrates a perspective view of a first embodiment of an exemplary rear housing 20b, and FIG. 3 illustrates a cross-sectional view of the rear housing 20b through plane 3-3 of FIG. 2. In the discussion that follows, reference will be made to both FIGS. 2 and 3. In some embodiments, rear housing 20b may include a first part 22 and one or more second parts 24 that together form the complete rear housing 20b. Although not a requirement, in some embodiments, the first part 22 and the second part 24 may be formed by an injection molding process. The separately molded first and second parts, 22, 24 may then be joined together to form the rear housing 20b. Although the first part 22 and the second parts 24 may be joined together by any known technique, in some embodiments, they may be removably joined together using fasteners.

In general, first part 22 may be formed from any type of material that has the desired structural characteristics (strength, toughness, rigidity, etc.) of the rear housing 20b. In some embodiments, the first part 22 may be made of a plastic material. Any type of plastic material (such as, for example, polyamide, polycarbonate, polypropylene, PET (polyethylene terephthalate), PMMA (polymethylmethacrylate), ABS (acrylonitrile butadiene styrene), etc.) may be used to form the first part 22. The first part 22 may be molded in the external shape of the mobile phone 10 with sections removed to accommodate the one or more second parts 24. The first part 22 may include steps (or other features) that support and mate with corresponding regions of second part 24. First part 22 may also include openings configured to accommodate components such as the battery door 16 and camera 18 (see FIG. 1B). Through-holes 26 may also be provided on the mating regions of the first and second parts 22, 24 to serve as attachment features.

The second part 24 may be molded using a plastic material that has been modified to suit a Laser Direct Structuring (LDS) process. LDS is a method that can be used to form conductive patterns on a modified plastic substrate. In the LDS process, a laser traces a high-resolution pattern directly onto a plastic part containing a special additive. The laser activates the additive in the plastic and enables conductive patterns to be selectively formed on the activated region. After activation, patterns are formed on the activated region by an electroplating (or other suitable) process. Using LDS, complex three-dimensional conductive patterns, such as antenna patterns, can be formed on an injection molded part.

Any type of plastic material suited for an LDS process (referred to herein as “LDS plastic”) may be used to form the second part 24. In some embodiments, the LDS plastic may include a plastic material (for instance, a plastic material as discussed above with reference to the first part 22) mixed with a laser activatable metal additive. After initially forming second part 24, an antenna 28 of an electrically conductive material having the desired shape and configuration is then formed on the second part 24 using an LDS process. Any type of metal may be used to make antenna 28. In some embodiments, antenna 28 may include metals such as aluminum and copper. In some embodiments, a coating may be applied on top of the antenna 28 to impart desirable characteristics to the antenna 28. For instance, in some embodiments, a coating of a scratch resistant and/or an oxidation resistant material (such as, a nickel or a gold coating) may be deposited on the antenna 28 for scratch and/or oxidation resistance.

In some embodiments, the LDS process may also be used to form other circuit patterns on the rear housing 20. These desired circuit patterns may be formed on the same second part 24 that includes the antenna 28 or, as illustrated in FIG. 2, a different second part 24 made of LDS plastic. For example, in some embodiments, electrical control circuit traces 30 that connect to volume control knobs 34, and electrical control circuit traces 32 that connect to a power switch 36 of the mobile phone 10 may also be formed on a different second part 24. When the mobile phone 10 is assembled, traces 30, 32 may connect to the electronic circuits within the housing 20 to provide electrical connectivity for the volume control knobs 34 and the power switch 36. These external control circuit traces 30, 32 may be connected to the electronic circuits within the housing 20 in any known manner. Additional or alternative control circuit traces may further be provided for one or more of a camera button, lock button, mute button, push-to-talk button, and any other user interface button with which mobile phone 10 may be provided. In some embodiments, wires may be soldered between connection points of the LDS circuits and circuit boards within the housing 20. In some embodiments, conductive via's (or plated through holes) through the second part 24 may connect the LDS circuit on the external surface of the second part 24 to a connection point on the internal surface of the second part 24, and connectors (such as, for example, spring loaded connectors) may connect these connection points to circuit boards within the housing 20.

After initially forming the antenna 28 and other circuit patterns, the one or more second parts 24 may be positioned on the first part 22 such that mating through-holes 26 of these parts align. Fasteners (such as, for example, screws) may be extended through these through-holes 26 (and in some case, circuit boards and/or other electronic circuits contained within the housing 20) to engage with features on the front housing 20a to attach the first part 22 to the second part 24, and the rear housing 20b to the front housing 20a. In this configuration, the antenna 28 (and circuits 30, 32) may be electrically coupled to electronic circuits within the housing 20 and configured to transmit and to receive signals.

In the first embodiment of rear housing 20b described above (and illustrated in FIGS. 2 and 3), the rear housing 20b is made of two or more parts. That is, the rear housing 20b includes a first part 22 made of any material (plastic or another) configured to provide structural support attached to one or more second parts 24 made of an LDS plastic. The second part 24 includes conductive circuits and/or traces formed by an LDS process thereon.

In a second embodiment illustrated in FIG. 4, the entire rear housing 20b is formed entirely of an LDS plastic material. As illustrated in FIG. 4, the second part 124 has a substantially rectangular shape in a plane perpendicular to the thickness direction of the mobile phone. And, unlike the first embodiment, the length and the width of the second part 124 are equal to the length and the width of the mobile phone 10, respectively. It is also contemplated that, in some embodiments, the length and/or the width of the second part 124 may only be substantially equal to the length and/or the width of the mobile phone 10, respectively. The second part 124 extends through the entire thickness of the rear housing 20b. That is, an external surface of the second part 124 forms the surface on which the antenna 28 (and other circuits) is formed by LDS, and an internal surface of the second part 124 bounds the enclosed volume within the housing 20 that contains electronic circuits of the mobile phone 10. In some embodiments, the second part 124 may be formed by injection molding an LDS plastic in the shape of the rear housing 20b. In some embodiments, second part 124 may be formed as a single continuous piece of LDS plastic. In alternative embodiments, second part 124 may be formed from multiple pieces of LDS plastic fastened together via laser welding, ultrasonic welding, or other processes known in the art. The second part 124 includes openings for the battery door 16, camera 18 (see FIG. 1B) and other components of the mobile phone 10.

After initially forming the second part 124, the antenna 28 of a desired shape and configuration may be formed on the external surface of the second part 124 by LDS. In some embodiments, other control circuit patterns, such as control circuit 30 for volume control, as well as control circuit 32 for power control and control circuits for enabling one or more of a camera button, lock button, mute button, push-to-talk button, and any other user interface button, may also be formed on the second part 124 using LDS. The antenna 28 and other circuits on the external surface of the second part 124 may be electrically connected to electronic circuits within the mobile phone 10 as described previously. The second part 124 may also include through-holes 26 that allow a fastener to pass through and to attach with the front housing 20a (or another component).

Although the antenna 28 (and other circuits) is described as being formed on the rear housing 20b, this is only exemplary. It is contemplated that some or all of these conductive structures may also be formed by an LDS process on the front housing 20a. Forming the entire rear housing 20b of an LDS plastic material, and incorporating the antenna 28 on the rear housing 20b, reduces the number of piece parts needed to form the housing 20, simplifies assembly, and reduces related costs.

In alternative embodiments, a plurality of antennas 28 may be formed on rear housing 20b via laser direct structuring. For example, mobile phone 10 may require antennas for multiple different communication modes, including, e.g., WiFi, BlueTooth, GSM, LTE, etc. Other electronics devices consistent with the present disclosure may also require multiple antennas 28 for various reasons. Thus, embodiments consistent with the present disclosure may include any number of antennas 28 to be formed on a housing of an electronics device through laser direct structuring.

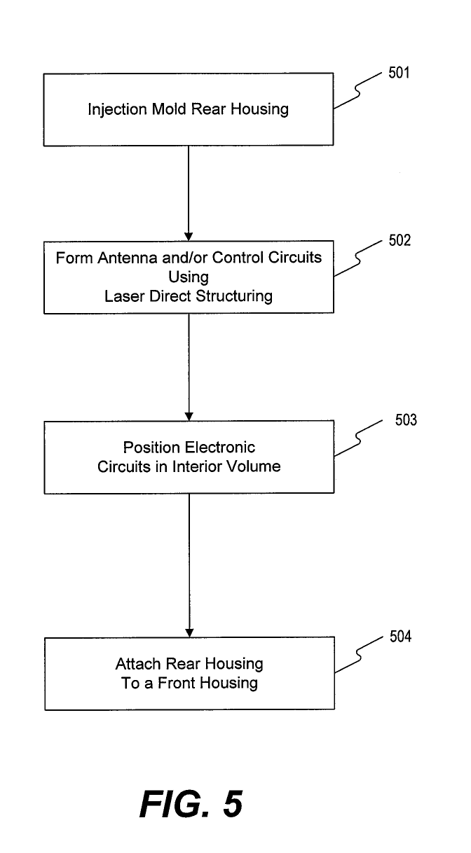

FIG. 5 is a flowchart depicting the steps of an exemplary method, consistent with the present disclosure, to manufacture a portable electronic device. At step 501, a rear housing 20b of the desired shape is first injection molded using LDS plastic, either of a single part or multiple parts, as discussed above. At step 502, an antenna and, optionally, other circuits (e.g., control circuits, etc.), are formed on the surface of rear housing 20b using laser direct structuring. In using laser direct structuring to form an antenna or other circuits, a laser beam is used to trace the desired antenna pattern on an external surface of the rear housing 20b. The laser beam activates the metal additives included in the LDS plastic. An electroplating process is then used to form the antenna 28 (and other circuits) over the activated pattern on the rear housing 20b. To complete the manufacture of a portable electronic device using the rear housing 20b, the electronic circuits of the electronic device are positioned in the interior volume formed between the front housing 20a and the rear housing 20b, at step 503. Finally, at step 504, the rear housing 20b is attached to the front housing 20a. In the assembled configuration, antenna 28 and other circuits on the rear housing 20b may contact and electrically couple with the electronic circuits within the housing 20.

The use of laser direct structuring to form an antenna or other circuitry on a surface of a mobile phone housing may provide several advantages over conventional techniques. Integrating an antenna or other circuitry into a housing reduces the number of separate parts and also reduces design complexity, which may reduce manufacturing costs. The number of parts may be further reduced in applications requiring several antennas. Such integration may also provide a more robust design, as potentially failure prone elements such as adhesives, snaps, and/or heat stakes, commonly used to attach antennas or other circuitry to housings, are eliminated. An integrated design may also reduce the number of parts that may fail. Additional strength may also be provided by a single continuous housing, with no requirement to remove portions of the housing to accommodate modules for antennas or other circuitry. Furthermore, forming an antenna directly on the surface of a housing may permit the reduction of overall device thickness, as the requirement of stacking of an antenna carrying module with the housing may be eliminated. Additional advantages of the disclosed embodiments will be clear to a person of skill in the art.

While specific embodiments have been described in detail, it will be appreciated by those skilled in the art that various modifications and alternatives to those details could be developed in light of the overall teachings of the disclosure. Accordingly, the particular arrangements disclosed are meant to be illustrative only and not limiting.

What is claimed is:

1. A portable electronic device comprising:
a rear housing formed entirely of a modified plastic material configured for laser direct structuring; and
an antenna formed on a surface of the rear housing using laser direct structuring.

2. The portable electronic device of claim 1, wherein the rear housing further includes at least one control circuit formed by laser direct structuring.

3. The portable electronic device of claim 1, wherein the rear housing has a substantially rectangular shape and has a length and a width substantially equal to a length and a width of the portable electronic device, respectively.

4. The portable electronic device of claim 1, wherein an external surface of the rear housing is the surface on which the antenna is formed, and an internal surface of the rear housing bounds an enclosed interior volume that includes electronic circuits of the portable electronic device.

5. The portable electronic device of claim 1, further comprising at least one additional antenna formed on a surface of the rear housing using laser direct structuring.

6. The portable electronic device of claim 1, further including a front housing attached to the rear housing, wherein the front housing and the rear housing define an enclosed interior volume therebetween.

7. The portable electronic device of claim 1, wherein the rear housing includes one or more openings configured to accommodate components of the portable electronic device.

8. The portable electronic device of claim 1, wherein the modified plastic material includes one of the following mixed with a laser activatable metal additive: polyamide, polycarbonate, polypropylene, polyethylene terephthalate, polymethylmethacrylate, or acrylonitrile butadiene styrene.

9. A portable electronic device comprising:
a front housing;
a substantially rectangular rear housing coupled to the front housing to enclose an interior volume therebetween, wherein the rear housing is made of a modified plastic material configured for laser direct structuring; and
an antenna formed on an external surface of the rear housing by laser direct structuring, wherein an internal surface of the rear housing bounds the interior volume of the portable electronic device.

10. The portable electronic device of claim 9, wherein the rear housing is formed entirely of the modified plastic material.

11. The portable electronic device of claim 9, wherein the rear housing further includes at least one control circuit formed by laser direct structuring.

12. The portable electronic device of claim 9, wherein the rear housing has a length and a width equal to a length and a width of the portable electronic device, respectively.

13. The portable electronic device of claim 9, further comprising at least one additional antenna formed on a surface of the rear housing using laser direct structuring.

14. The portable electronic device of claim 9, wherein the rear housing includes one or more openings configured to accommodate components of the portable electronic device.

15. A method of manufacturing a portable electronic device, comprising:
injection molding a rear housing of the portable electronic device entirely of a plastic material configured for laser direct structuring;
forming an antenna on an external surface of the rear housing using laser direct structuring; and
attaching the rear housing to a front housing to enclose an interior volume therebetween, wherein an internal surface of the rear housing bounds the interior volume.

16. The method of claim 15, further including forming at least one control circuit on the external surface of the rear housing using laser direct structuring.

17. The method of claim 15, further including positioning electronic circuits in the interior volume.

18. The method of claim 17, further including electrically connecting the antenna to the electronic circuits.

19. The method of claim 15, wherein the injection molding includes injection molding the rear housing using one of the following mixed with a laser activatable metal additive: polyamide, polycarbonate, polypropylene, polyethylene terephthalate, polymethylmethacrylate, or acrylonitrile butadiene styrene.

20. The method of claim 15, further including forming at least one additional antenna on an external surface of the rear housing using laser direct structuring.
